(19) United States
(12) Patent Application Publication
(10) Pub. No.: US 2016/0092232 A1
(43) Pub. Date: Mar. 31, 2016

(54) PROPAGATING CONSTANT VALUES USING A COMPUTED CONSTANTS TABLE, AND RELATED APPARATUSES AND METHODS

(71) Applicant: QUALCOMM Incorporated, San Diego, CA (US)

(72) Inventor: Michael William Morrow, Wilkes Barre, PA (US)

(21) Appl. No.: 14/498,508

(22) Filed: Sep. 26, 2014

(51) Int. Cl. G06F 9/38; G06F 9/30

(52) U.S. Cl. CPC G06F 9/3838; G06F 9/30145

(57) ABSTRACT

Propagating constant values using a computed constants table, and related apparatuses and methods are disclosed. In one aspect, an apparatus comprises an instruction processing circuit configured to provide a computed constants table containing one or more entries. Each entry of the computed constants table comprises an attribute and a computed constant value. The instruction processing circuit is configured to detect a deterministic instruction in an instruction stream. Upon detecting the deterministic instruction, the instruction processing circuit determines whether an attribute of the deterministic instruction matches an entry of the computed constants table. If so, the instruction processing circuit provides the computed constant value stored in the entry to at least one dependent instruction. In this manner, a computed constant value may be propagated between instructions without requiring the deterministic instruction to be re-executed.

### BACKGROUND

I. Field of the Disclosure

The technology of the disclosure relates generally to constant propagation during execution of a computer program by a processor.

II. Background

Many compilers are capable of performing an optimization process known as “constant propagation” when compiling source code into an executable computer program. Conventional constant propagation involves detecting, at compilation, an instance of a computer program instruction or function call that results in a same constant value being computed for all possible executions of the program. Based on this knowledge, a compiler may then optimize the computer program to more efficiently propagate the computed constant value to other dependent instructions that receive the computed constant value as an input.

However, under some circumstances, compile-time constant propagation may be impractical or may generate suboptimal results. For example, a compiler's awareness of constant values may be hindered in cases in which blocks of computer instructions are compiled separately. In some programs, variables may be constant only on a subset of program paths due to the presence of multiple paths to an instruction block within a program. Moreover, constant propagation may result in “code bloat,” or an excessively large compiled program that may make optimization too costly in terms of storage.

### SUMMARY OF THE DISCLOSURE

Aspects disclosed in the detailed description include propagating constant values using a computed constants table. Related apparatuses and methods are also disclosed. In this regard, in one aspect, an instruction processing circuit is provided to enable constant propagation functionality at run time of computer program instructions. The instruction processing circuit may provide a computed constants table for caching computed constant values to be propagated between instructions. The instruction processing circuit may be configured to detect a deterministic instruction in an instruction stream. As used herein, a “deterministic instruction” is an instruction that can be determined to always produce a given output when provided with a particular input. In some aspects, a deterministic instruction may be an instruction that operates on an immediate constant value, or that takes as input only a constant value or a previously computed constant value cached in the computed constants table. After detecting the deterministic instruction, the instruction processing circuit determines whether an attribute (an address, as a non-limiting example) of the deterministic instruction matches an entry of the computed constants table. If the attribute of the deterministic instruction matches the entry of the computed constants table, a computed constant value stored in the entry of the computed constants table is provided for execution of at least one dependent instruction on the deterministic instruction. In this manner, the computed constant value may be propagated to dependent instructions without requiring re-execution of the deterministic instruction, resulting in improved processor performance. In some aspects, the entry of the computed constants table may also store operands for the deterministic instruction. The instruction processing circuit may then locate the entry in the computed constants table by further determining whether inputs for the detected deterministic instruction match the operands stored in the entry.

In another aspect, an apparatus comprising an instruction processing circuit is provided. The instruction processing circuit is configured to detect, in an instruction stream, a deterministic instruction. The instruction processing circuit is further configured to determine whether an attribute of the deterministic instruction matches an entry of a computed constants table. The instruction processing circuit is also configured to, responsive to determining that the attribute of the deterministic instruction matches the entry of the computed constants table, provide a constant value stored in the entry of the computed constants table for execution of at least one dependent instruction on the deterministic instruction.

In another aspect, a method for providing constant propagation is provided. The method comprises detecting, in an instruction stream, a deterministic instruction. The method further comprises determining whether an attribute of the deterministic instruction matches an entry of a computed constants table. The method also comprises, responsive to determining that the attribute of the deterministic instruction matches the entry of the computed constants table, providing a constant value stored in the entry of the computed constants table for execution of at least one dependent instruction on the deterministic instruction.

In another aspect, an apparatus comprising an instruction processing circuit is provided. The instruction processing circuit comprises a means for detecting, in an instruction stream, a deterministic instruction. The instruction processing circuit further comprises a means for determining whether an attribute of the deterministic instruction matches an entry of a computed constants table. The instruction processing circuit also comprises a means for providing a constant value stored in the entry of the computed constants table for execution of at least one dependent instruction on the deterministic instruction, responsive to determining that the attribute of the deterministic instruction matches the entry of the computed constants table.

### BRIEF DESCRIPTION OF THE FIGURES

FIG. 1 is a block diagram of an exemplary computer processor including an instruction processing circuit for propagating constant values using a computed constants table;

FIG. 2 is a diagram illustrating exemplary elements of the computed constants table of FIG. 1;

FIGS. 3A-3I illustrate exemplary communications flows for generating an entry in the computed constants table of FIG. 1, and providing a computed constant value of the entry to a dependent instruction by the instruction processing circuit of FIG. 1;

FIGS. 4A and 4B are flowcharts illustrating exemplary operations for propagating constant values using the computed constants table of the instruction processing circuit of FIG. 1;

FIG. 5 is a flowchart illustrating exemplary operations for detecting a deterministic instruction by the instruction processing circuit of FIG. 1; and

FIG. 6 is a block diagram of an exemplary processor-based system that can include the instruction processing circuit of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include propagating constant values using a computed constants table. Related apparatuses and methods are also disclosed. In this regard, in one aspect, an instruction processing circuit is provided to enable constant propagation functionality at run time of computer program instructions. The instruction processing circuit may provide a computed constants table for caching computed constant values to be propagated between instructions. The instruction processing circuit may be configured to detect a deterministic instruction in an instruction stream. As used herein, a “deterministic instruction” is an instruction that can be determined to always produce a given output when provided with a particular input. In some aspects, a deterministic instruction may be an instruction that operates on an immediate constant value, or that takes as input only a constant value or a previously computed constant value cached in the computed constants table. After detecting the deterministic instruction, the instruction processing circuit determines whether an attribute (an address, as a non-limiting example) of the deterministic instruction matches an entry of the computed constants table. If the attribute of the deterministic instruction matches the entry of the computed constants table, a computed constant value stored in the entry of the computed constants table is provided for execution of at least one dependent instruction on the deterministic instruction. In this manner, the computed constant value may be propagated to dependent instructions without requiring re-execution of the deterministic instruction, resulting in improved processor performance. In some aspects, the entry of the computed constants table may also store operands for the deterministic instruction. The instruction processing circuit may then locate the entry in the computed constants table by further determining whether inputs for the detected deterministic instruction match the operands stored in the entry.

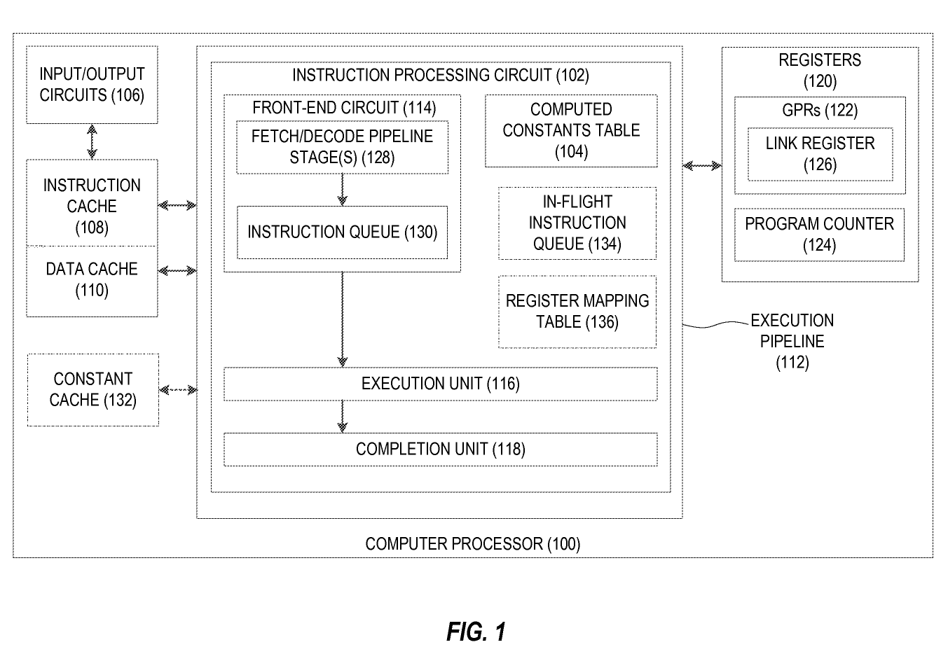

In this regard, FIG. 1 is a block diagram of an exemplary computer processor 100. The computer processor 100 includes an instruction processing circuit 102 providing a computed constants table 104 for propagating constant values and detecting computed constant value mispredictions, as disclosed herein. The computer processor 100 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages.

The computer processor 100 includes input/output circuits 106, an instruction cache 108, and a data cache 110. The computer processor 100 further comprises an execution pipeline 112, which includes a front-end circuit 114, an execution unit 116, and a completion unit 118. The computer processor 100 additionally includes registers 120, which comprise one or more general purpose registers (GPRs) 122, a program counter 124, and a link register 126. In some aspects, such as those employing the ARM® ARM7™ architecture, the link register 126 is one of the GPRs 122, as shown in FIG. 1. Alternately, some aspects, such as those utilizing the IBM® PowerPC® architecture, may provide that the link register 126 is separate from the GPRs 122.

In exemplary operation, the front-end circuit 114 of the execution pipeline 112 fetches instructions (not shown) from the instruction cache 108, which in some aspects may be an on-chip Level 1 (L1) cache, as a non-limiting example. The fetched instructions are decoded by the front-end circuit 114 and issued to the execution unit 116. The execution unit 116 executes the issued instructions, and the completion unit 118 retires the executed instructions. In some aspects, the completion unit 118 may comprise a write-back mechanism (not shown) that stores results of instruction execution in one or more of the registers 120. It is to be understood that the execution unit 116 and/or the completion unit 118 may each comprise one or more sequential pipeline stages. In the example of FIG. 1, the front-end circuit 114 comprises one or more fetch/decode pipeline stages 128, which enable multiple instructions to be fetched and decoded concurrently. An instruction queue 130 for holding the fetched instructions pending dispatch to the execution unit 116 is communicatively coupled to one or more of the fetch/decode pipeline stages 128.

Some aspects of the computer processor 100 of FIG. 1 may provide an optional constant cache 132 that is communicatively coupled to one or more elements of the execution pipeline 112. The constant cache 132 may provide a quick-access mechanism by which a value previously stored in one of the registers 120 may be provided to an instruction that uses the value as an input operand. The constant cache 132 may thus improve the performance of the computer processor 100 by providing access to stored values more quickly than the registers 120.

For various reasons, the instructions processed within the execution pipeline 112 may not have been optimized using constant propagation at compilation. In this regard, the instruction processing circuit 102 of FIG. 1 provides the computed constants table 104 for propagating constant values to dependent instructions at run time of computer program instructions. The instruction processing circuit 102 is configured to detect deterministic instructions (not shown) in an instruction stream (not shown) that are processed within the execution pipeline 112. In some aspects, the instruction processing circuit 102 may be configured to detect a deterministic instruction by determining that the deterministic instruction operates on an immediate constant value, or takes as input only a constant value or a previously computed constant value in the computed constants table 104.

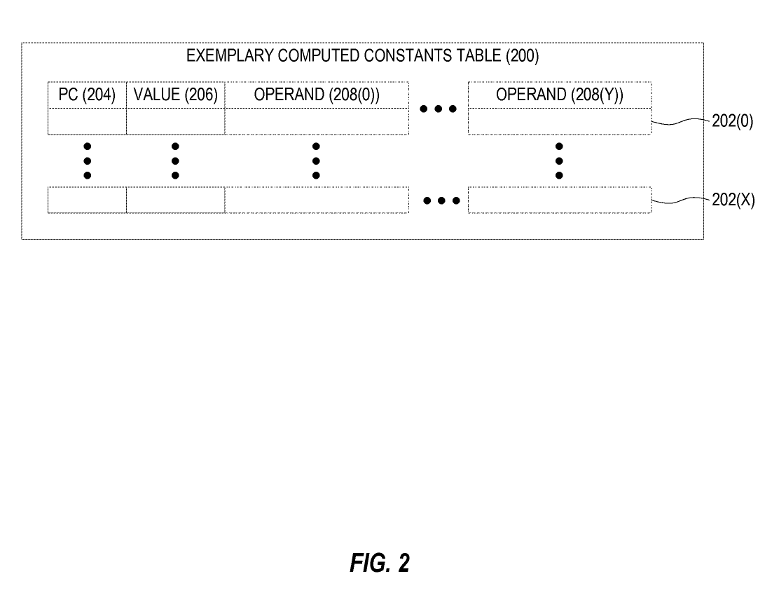

As each deterministic instruction is fetched by the front-end circuit 114 of the instruction processing circuit 102, the instruction processing circuit 102 consults the computed constants table 104. The computed constants table 104 contains one or more entries (not shown). Each entry may include an attribute of a previously-detected deterministic instruction, and a computed constant value that was previously generated by the deterministic instruction corresponding to the attribute. Some aspects may provide that the attribute comprises an address of the deterministic instruction and/or an index of the deterministic instruction, as non-limiting examples. In some aspects, the entry may also include one or more operands of the deterministic instruction. Exemplary elements of the computed constants table 104 are discussed in greater detail below with respect to FIG. 2.

The instruction processing circuit 102 determines whether an attribute of the deterministic instruction being fetched matches an entry of the computed constants table 104. According to some aspects disclosed herein, the instruction processing circuit 102 may be configured to further determine whether one or more inputs (not shown) for the detected deterministic instruction corresponds to one or more operands stored in the entry. If so (i.e., a “hit”), the instruction processing circuit 102 provides the computed constant value from the entry to at least one dependent instruction. In aspects wherein the computer processor 100 includes the optional constant cache 132, the instruction processing circuit 102 may provide the computed constant value to the at least one dependent instruction via the constant cache 132 (e.g., writing the computed constant value to the constant cache 132). In this manner, the instruction processing circuit 102 may leverage existing functionality of the constant cache 132 to provide the computed constant value to the at least one dependent instruction, thus avoiding the need to implement an additional communications path. Some aspects may provide that the instruction processing circuit 102 comprises a communications pathway (not shown) to provide the computed constant value to the at least one dependent instruction. The at least one dependent instruction may thus obtain the computed constant value for the deterministic instruction without requiring the deterministic instruction to be re-executed.

According to some aspects disclosed herein, if the instruction processing circuit 102 detects a deterministic instruction but does not find the attribute of the deterministic instruction in an entry of the computed constants table 104, a “miss” occurs. In this case, the instruction processing circuit 102 may generate an entry in the computed constants table 104 corresponding to the deterministic instruction upon execution of the deterministic instruction. The generated entry includes the attribute of the deterministic instruction, and stores the computed constant value generated by the deterministic instruction as the computed constant value of the entry. In some aspects, the entry may also include one or more operands in which a corresponding one or more inputs for the deterministic instruction may be stored. If and when the deterministic instruction is again detected by the instruction processing circuit 102, a “hit” in the computed constants table 104 may occur, and the computed constant value may be provided to a dependent instruction.

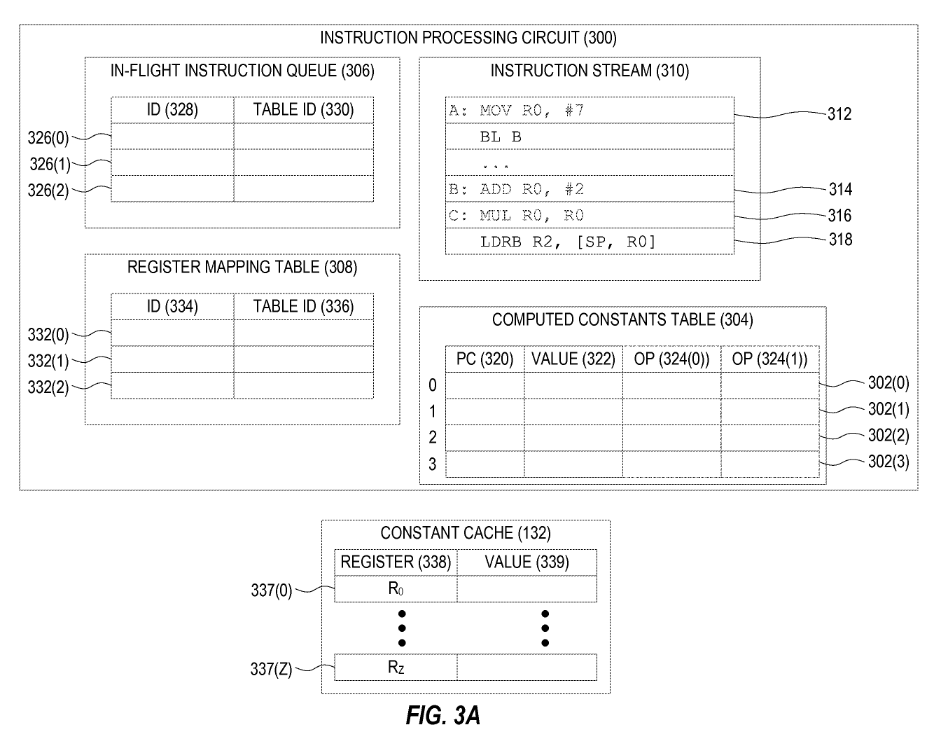

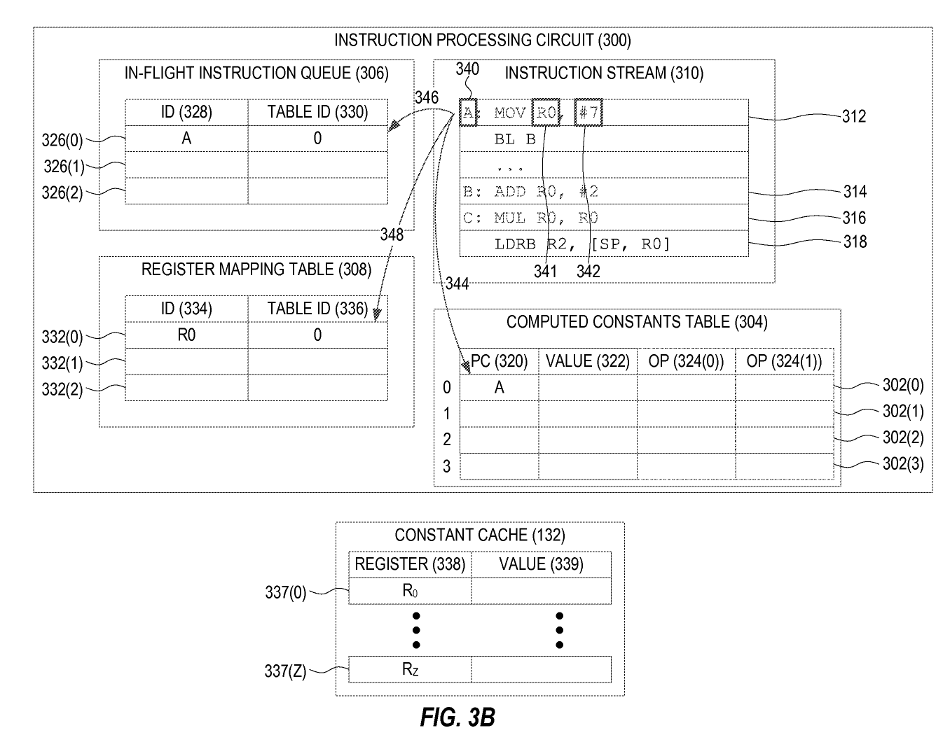

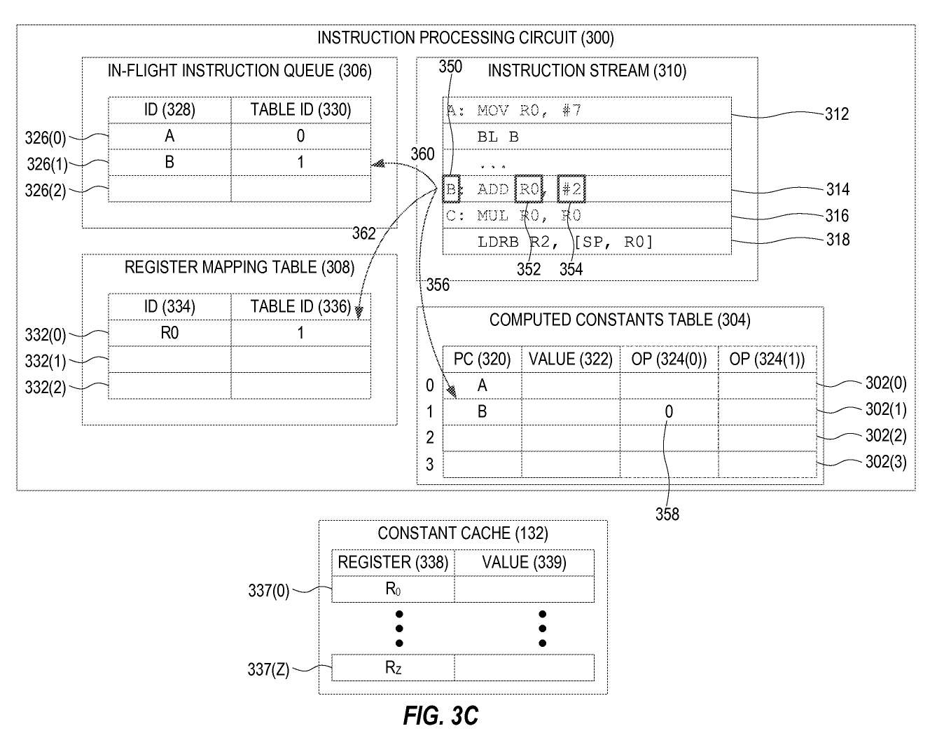

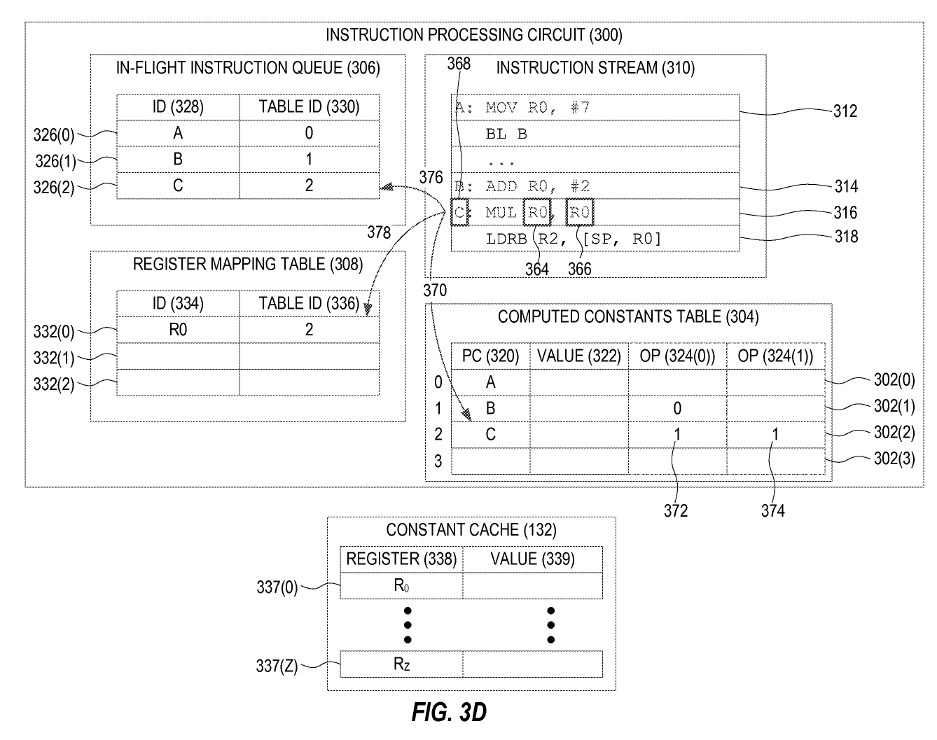

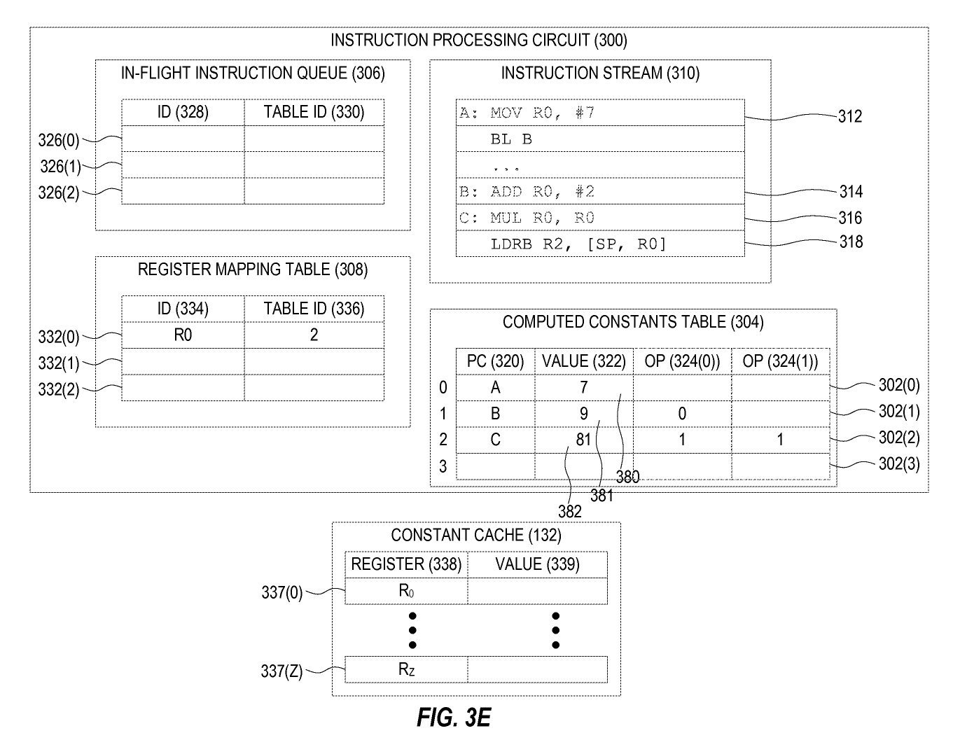

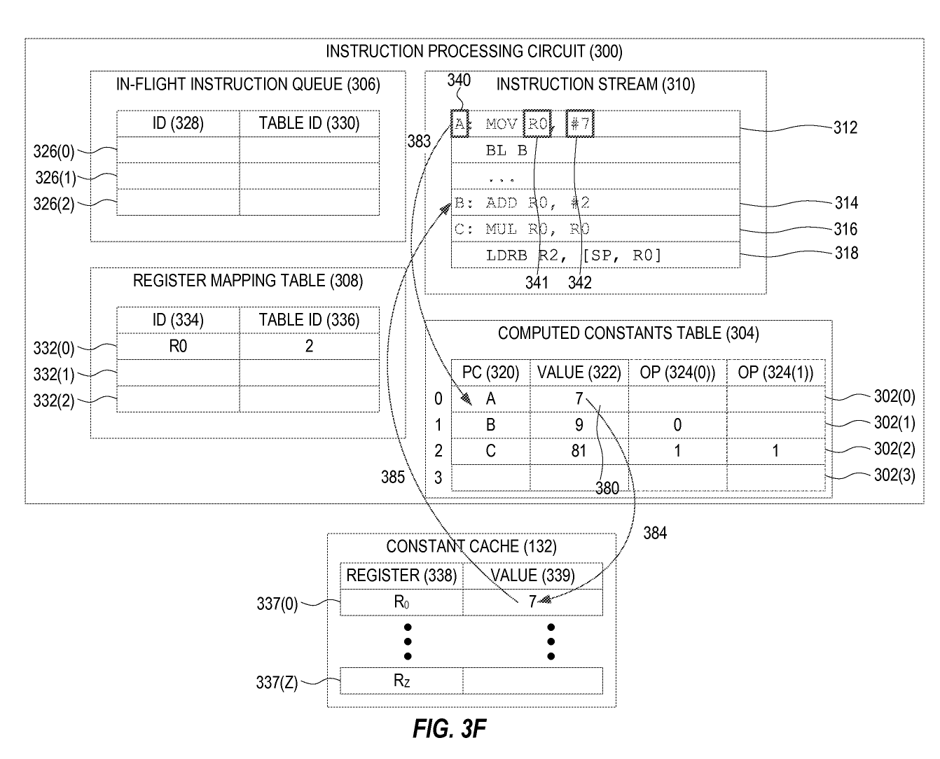

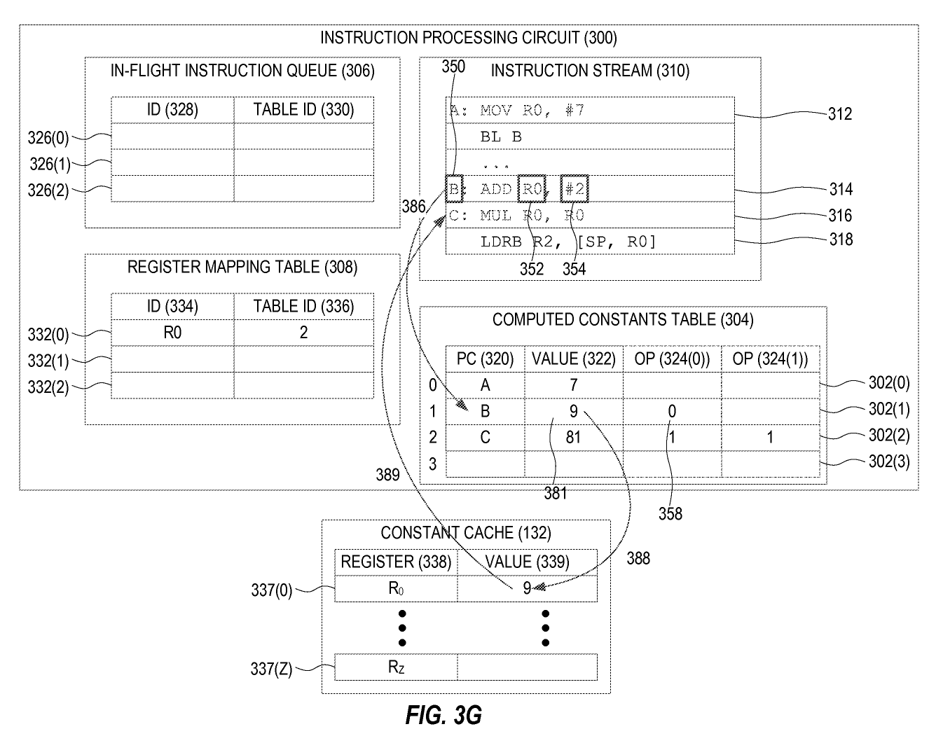

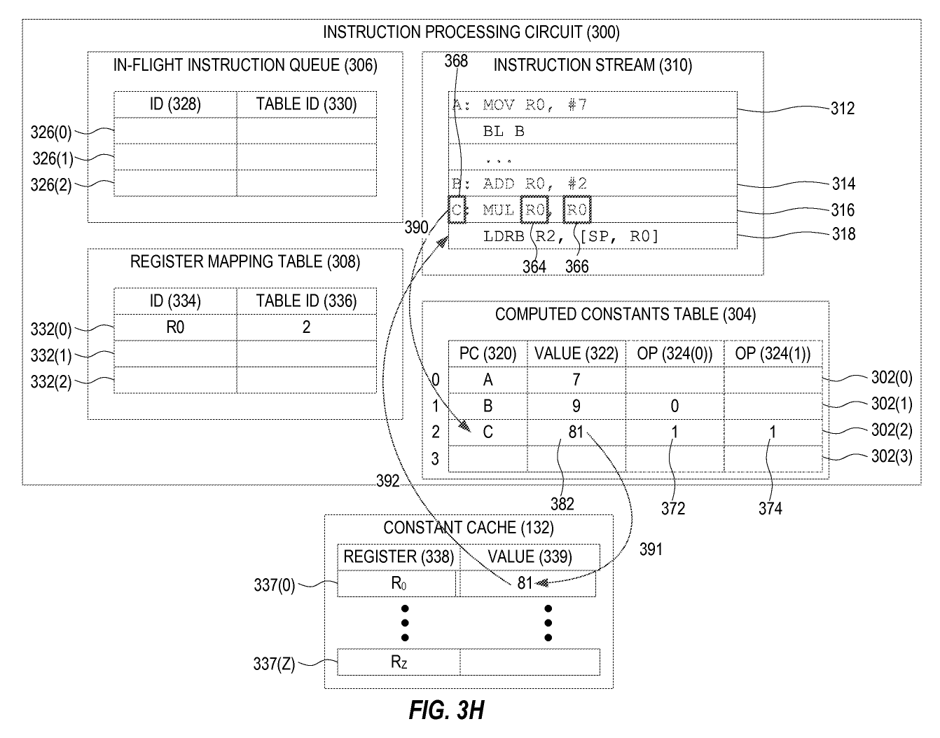

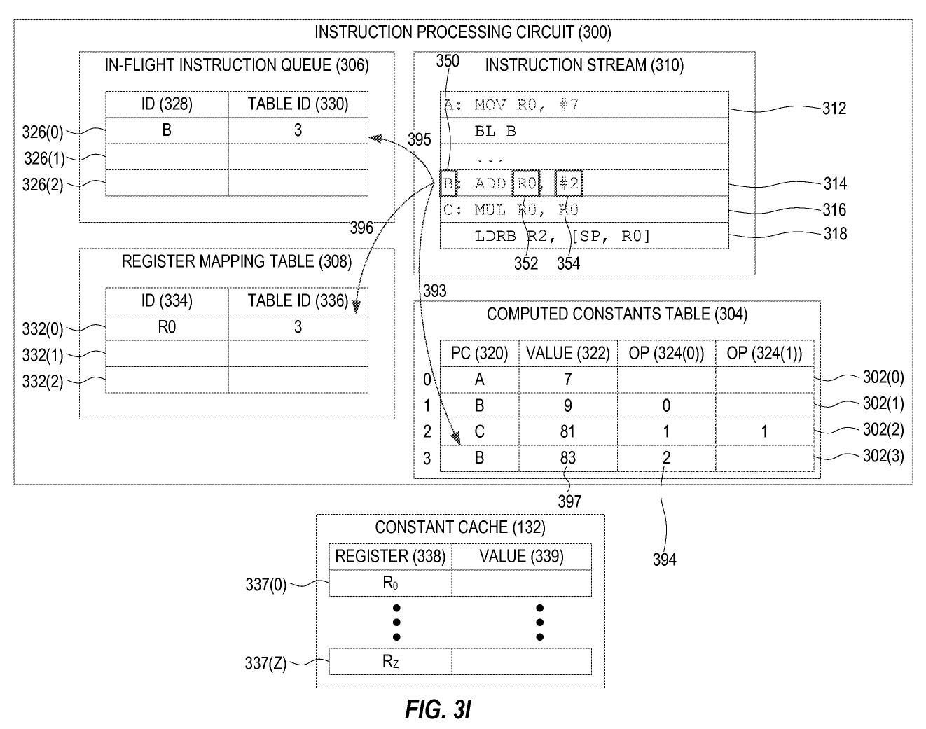

Some aspects may provide that the instruction processing circuit 102 includes additional elements to facilitate constant propagation. As non-limiting examples, the instruction processing circuit 102 may include an in-flight instruction queue 134 and/or a register mapping table 136. The in-flight instruction queue 134 may be used in some aspects to track “in-flight” instructions (i.e., instructions that have been fetched but not yet executed), while the register mapping table 136 may be used to map one or more of the registers 120 to an entry in the computed constants table 104. The use of the in-flight instruction queue 134 and the register mapping table 136 is discussed in greater detail below with respect to FIGS. 3A-3I.

FIG. 2 illustrates an exemplary computed constants table 200 that may represent an aspect of the computed constants table 104 of FIG. 1. Elements of FIG. 1 are referenced for the sake of clarity in describing FIG. 2. As seen in FIG. 2, the computed constants table 200 includes multiple entries 202(0)-202(X). Each entry 202(0)-202(X) includes a program counter (PC) field 204, which represents an attribute of a deterministic instruction previously detected by the instruction processing circuit 102 of FIG. 1. In some aspects, the PC field 204 may store the attribute comprising a physical address of the deterministic instruction, while some aspects may provide that the PC field 204 stores the attribute comprising a virtual address of the deterministic instruction. In the latter case, the instruction processing circuit 102 may include additional logic (not shown) in order to invalidate one or more of the entries 202(0)-202(X) when a mapping of a virtual address to a physical address changes. According to some aspects disclosed herein, the PC field 204 may store only a subset of the bits constituting the attribute of the deterministic instruction. Some aspects may provide that the attribute of the deterministic instruction comprises a physical register number of the deterministic instruction and/or a sequence number of the deterministic instruction.

Each of the entries 202(0)-202(X) also includes a value field 206. The value field 206 stores a computed constant value that is generated upon a first execution of the deterministic instruction. Upon subsequent detection of the deterministic instruction, the instruction processing circuit 102 may provide the computed constant value from the value field 206 to a dependent instruction. In some aspects, a size of the value field 206 may be smaller than a largest size of a constant value supported by the computer processor 100 to save processor area. As a non-limiting example, the computer processor 100 may support 64-bit constants, while the value field 206 may store only the lower 32 bits of a computed constant value. In aspects in which most computed constant values are comprised of 32 or fewer significant bits, the use of a smaller value field 206 may provide space and/or power savings with little to no impact on functionality of the computed constants table 200.

Some aspects may provide that each of the entries 202(0)-202(X) of the computed constants table 200 includes one or more operand fields 208(0)-208(Y). Each of the operand fields 208(0)-208(Y) may store a corresponding input of the deterministic instruction. By determining that an entry 202(0)-202(X) provides both an attribute and one or more operands for the deterministic instruction, the instruction processing circuit 102 may enable the computed constants table 200 to capture multiple paths to the same deterministic instruction. As a non-limiting example, two different constant values generated by a function call that is invoked from two different locations with two different sets of operands may be cached as two separate entries 202(0)-202(X).

According to some aspects disclosed herein, each of the one or more operand fields 208(0)-208(Y) may store a reference to another of the entries 202(0)-202(X), or may store a constant value. In some aspects, the operand fields 208(0)-208(Y) may store a mix of references and constant values, with a bit flag (not shown) associated with each of the operand fields 208(0)-208(Y) indicating whether a pointer or a value is stored therein.

It is to be understood that some aspects may provide that the entries 202(0)-202(X) of the computed constants table 200 may include other fields in addition to the fields illustrated in FIG. 2. As a non-limiting example, the entries 202(0)-202(X) may include one or more valid bits (not shown) indicative of a validity of the entries 202(0)-202(X) and/or of the constituent elements thereof. It is to be further understood that the computed constants table 200 in some aspects may be implemented as a cache configured according to associativity and replacement policies known in the art. In the example of FIG. 2, the computed constants table 200 is illustrated as a single data structure. However, in some aspects, the computed constants table 200 may also comprise more than one data structure or cache.

To better illustrate exemplary communications flows among the instruction processing circuit 102 and the computed constants table 104 of FIG. 1, FIGS. 3A-3I are provided. FIG. 3A provides an overview of elements of an instruction processing circuit 300, which corresponds to one aspect of the instruction processing circuit 102 of FIG. 1. FIGS. 3B-3E illustrate exemplary communications flows during generation of entries 302(0)-302(3) in a computed constants table 304, while FIGS. 3F-3H show exemplary communications flows during constant propagation using the computed constants table 304. For the sake of clarity, elements of FIG. 1 are referred to in describing FIGS. 3A-3I.

As seen in FIG. 3A, the instruction processing circuit 300 includes the computed constants table 304, and also includes an in-flight instruction queue 306 and a register mapping table 308, each of which is described in turn below. The instruction processing circuit 300 in this example processes an instruction stream 310, which comprises instructions 312, 314, 316, and 318. It is to be understood that the instruction 312 may be referred to herein as a “deterministic instruction 312,” while the instruction 318 may be referred to herein as a “dependent instruction 318.” Because the instructions 314 and 316 are also deterministic instructions that depend on constant values generated by preceding instructions, they may be referred to herein both as “deterministic instructions 314 and 316” as well as “dependent instructions 314 and 316.”

The computed constants table 304 illustrated in FIG. 3A includes the entries 302(0)-302(3). To facilitate propagation of computed constant values, each entry 302(0)-302(3) of the computed constants table 304 includes a program counter (PC) field 320, a value field 322, and two operand (OP) fields 324(0) and 324(1). The PC field 320 for each entry 302(0)-302(3) may be used to store an attribute comprising an address of a deterministic instruction that is detected by the instruction processing circuit 300. The value field 322 may store a computed constant value generated by the deterministic instruction associated with the attribute in the PC field 320. Likewise, the operand fields 324(0)-324(1) may store inputs of the deterministic instruction associated with the attribute in the PC field 320. It is to be understood that, although the computed constants table 304 of FIG. 3A includes four entries 302(0)-302(3), the computed constants table 304 in some aspects may include more or fewer entries.

As noted above, the instruction processing circuit 300 may use the in-flight instruction queue 306 of FIG. 3A to track “in-flight” instructions, i.e. instructions that have been fetched but not yet executed. Accordingly, the in-flight instruction queue 306 includes entries 326(0)-326(2), each of which comprises an identification (ID) field 328 and a table ID field 330. The ID field 328 of each of the entries 326(0)-326(2) stores an address of an in-flight instruction, while the table ID field 330 stores a reference to a corresponding entry 302(0)-302(2) of the computed constants table 304. It is to be understood that, although the in-flight instruction queue 306 of FIG. 3A includes three entries 326(0)-326(2), the in-flight instruction queue 306 in some aspects may include more or fewer entries.

The register mapping table 308 in the example of FIG. 3A may be used by the instruction processing circuit 300 to map a register, such as one of the registers 120 of FIG. 1, to one of the entries 302(0)-302(3) in the computed constants table 304. Thus, the register mapping table 308 provides entries 332(0)-332(2). Each of the entries 332(0)-332(2) includes an ID field 334, which identifies one of the registers 120. Each of the entries 332(0)-332(2) further includes a table ID field 336, which stores a reference to a corresponding entry 302(0)-302(3) of the computed constants table 304. It is to be understood that, although the register mapping table 308 of FIG. 3A includes three entries 332(0)-332(2), the register mapping table 308 in some aspects may include more or fewer entries.

The constant cache 132 shown in FIG. 3A (corresponding to the optional constant cache 132 of FIG. 1) comprises entries 337(0)-337(Z). Each of the entries 337(0)-337(Z) includes a register field 338 and a value field 339. The register field 338 of each entry 337(0)-337(Z) indicates one of the registers 120 of FIG. 1 associated with the entry 337(0)-337(Z), while the value field 339 indicates a computed constant value most recently stored in the corresponding register 120. As discussed above, the constant cache 132 may provide a quick-access mechanism providing speedier access to cached values than loading the values directly from the registers 120. It is to be understood that some aspects of the instruction processing circuit 300 may be configured with a different communications pathway to provide computed constant values from the computed constants table 304, and that in such aspects, the constant cache 132 may not be employed.

Referring now to FIG. 3B, communications flows in some aspects for establishing the entries 302(0)-302(3) in the computed constants table 304 are illustrated. As the instruction processing circuit 300 processes the instruction stream 310 for the first time, a first instance of the deterministic instruction 312 is detected, having an attribute 340 comprising an address A. In this example, the deterministic instruction 312 is a MOV instruction that takes inputs 341 and 342. The input 341 indicates a register R0 (i.e., one of the registers 120 of FIG. 1) as a target of the deterministic instruction 312, while the input 342 indicates that the deterministic instruction 312 operates on an immediate constant value (the value seven (7), in this example). In some aspects, the deterministic instruction 312 may be detected based on the fact that the deterministic instruction 312 operates directly on the immediate constant value.

The instruction processing circuit 300 checks the computed constants table 304, and determines that the attribute 340 does not match any of the entries 302(0)-302(3). Thus, in response to the “miss,” the instruction processing circuit 300 generates the entry 302(0) in the computed constants table 304, and stores the attribute 340 of the deterministic instruction 312 in the PC field 320, as indicated by arrow 344. The instruction processing circuit 300 also generates the entry 326(0) in the in-flight instruction queue 306, as indicated by arrow 346. In the entry 326(0), the attribute 340 of the deterministic instruction 312 is stored in the ID field 328, while an ID of zero (0) for the entry 302(0) of the computed constants table 304 is stored in the table ID field 330. As shown by arrow 348, the instruction processing circuit 300 further generates the entry 332(0) in the register mapping table 308. An identifier for the register R0 is stored in the ID field 334 of the entry 332(0), and an ID of zero (0) for the entry 302(0) of the computed constants table 304 is stored in the table ID field 336. Conventional processing of the deterministic instruction 312 then continues.

In FIG. 3C, the instruction processing circuit 300 detects the deterministic instruction 314 having an attribute 350 comprising an address B. The deterministic instruction 314 is an ADD instruction that receives inputs 352 and 354. The input 352 indicates that the register R0 is a source and target of the deterministic instruction 314, while the input 354 indicates that the deterministic instruction 314 operates on an immediate constant value (the value two (2), in this example). In some aspects, the deterministic instruction 314 may be detected based on determining that each of the inputs 352 and 354 corresponds to an existing entry in the computed constants table 304 or to an immediate constant value. In this example, the input 352 corresponds to the existing entry 302(0) of the computed constants table 304 (as indicated by the entry 332(0) of the register mapping table 308 of FIG. 3B), while the input 354 corresponds to an immediate constant value.

As in FIG. 3B, the instruction processing circuit 300 checks the computed constants table 304, and determines that the attribute 350 does not match any of the entries 302(0)-302(3). The instruction processing circuit 300 then generates the entry 302(1) in the computed constants table 304, and stores the attribute 350 of the deterministic instruction 314 in the PC field 320, as indicated by arrow 356. Because the input 352 of the deterministic instruction 314 corresponds to the existing entry 302(0), the instruction processing circuit 300 stores an ID of zero (0) for the entry 302(0) of the computed constants table 304 in the operand field 324(0) of the entry 302(1) as an operand 358. It is to be understood that, in some aspects disclosed herein, the instruction processing circuit 300 may store the computed constant value generated by the deterministic instruction 312 as operand 358 rather than storing a reference to the entry 302(0).

The instruction processing circuit 300 also generates the entry 326(1) in the in-flight instruction queue 306, as shown by arrow 360. In the entry 326(1), the attribute 350 of the deterministic instruction 314 is stored in the ID field 328, while an ID of one (1) for the entry 302(1) of the computed constants table 304 is stored in the table ID field 330. The instruction processing circuit 300 further updates the table ID field 336 of the entry 332(0) in the register mapping table 308 with an ID of one (1) for the entry 302(1) of the computed constants table 304, as indicated by arrow 362. This may serve to indicate to the instruction processing circuit 300 that the entry 302(1) will contain the most recent computed constant value for the register R0 corresponding to the input 352. Conventional processing of the deterministic instruction 314 then continues.

Referring now to FIG. 3D, the instruction processing circuit 300 detects the deterministic instruction 316 (which is a MUL instruction that receives inputs 364 and 366) having an attribute 368 comprising an address C. The inputs 364 and 366 indicate that the register R0 is both a source and a target of the deterministic instruction 316. In some aspects, the deterministic instruction 316 may be detected based on determining that the inputs 364 and 366 both correspond to an existing entry in the computed constants table 304 (in this example, the existing entry 302(1), as indicated by the entry 332(0) of the register mapping table 308 of FIG. 3C).

After determining that the attribute 368 does not match any of the entries 302(0)-302(3) of the computed constants table 304, the instruction processing circuit 300 generates the entry 302(2), as indicated by arrow 370. The attribute 368 of the deterministic instruction 316 is stored in the PC field 320, while an ID of one (1) for the entry 302(1) of the computed constants table 304 is stored in the operand fields 324(0) and 324(1) of the entry 302(2) as operands 372 and 374, respectively.

As in FIGS. 3B and 3C, the instruction processing circuit 300 generates the entry 326(2) in the in-flight instruction queue 306, as shown by arrow 376. The attribute 368 of the deterministic instruction 316 is stored in the ID field 328, while an ID of two (2) for the entry 302(2) of the computed constants table 304 is stored in the table ID field 330. The instruction processing circuit 300 again updates the table ID field 336 of the entry 332(0) in the register mapping table 308 with an ID of two (2) for the entry 302(2) of the computed constants table 304, as indicated by arrow 378. The deterministic instruction 316 is then processed conventionally.

In FIG. 3E, a write-back of the computed constant values resulting from execution of the deterministic instructions 312, 314, and 316 takes place. In response, the instruction processing circuit 300 updates the entries 302(0)-302(3) to store the computed constant values in the computed constants table 304. In particular, the value field 322 of the entry 302(0) is updated to store a value of “7” as a computed constant value 380 from the instruction 312. The entries 302(1) and 302(2) are likewise updated to store values of “9” and “81” as computed constant values 381 and 382 from the instructions 314 and 316, respectively. In some aspects, the instruction processing circuit 300 may employ the in-flight instruction queue 306 to determine in which of the entries 302(0)-302(3) the computed constant values 380, 381, and 382 are to be stored.

FIGS. 3F-3I illustrate use of the entries 302(0)-302(3) of the computed constants table 304 for propagating computed constant values. As seen in FIG. 3F, the instruction processing circuit 300 processes the instruction stream 310 for a second time, and detects a second instance of the deterministic instruction 312. As indicated by arrow 383, the instruction processing circuit 300 checks the computed constants table 304 to determine whether the attribute 340 matches any of the entries 302(0)-302(3), and this time locates the entry 302(0).

In response, the instruction processing circuit 300 writes the computed constant value 380 provided by the entry 302(0) to the entry 337(0) in the constant cache 132 corresponding to the register R0, as indicated by arrow 384. The computed constant value 380 may then be provided to the dependent instruction 314 (i.e., the next deterministic instruction 314) via the constant cache 132, as indicated by arrow 385. In this manner, the dependent instruction 314 is able to receive the computed constant value 380 without the deterministic instruction 312 having to be re-executed.

A similar process occurs in FIG. 3G. The instruction processing circuit 300 detects a second instance of the deterministic instruction 314, and locates the entry 302(1), as indicated by arrow 386. In this example, the instruction processing circuit 300 may locate the entry 302(1) by determining that the attribute 350 of the deterministic instruction 314 matches the entry 302(1), and by further determining that the input 352 of the deterministic instruction 314 corresponds to the operand 358 in the entry 302(1). The instruction processing circuit 300 updates the entry 337(0) in the constant cache 132 with the computed constant value 381 provided by the entry 302(1), as indicated by arrow 388. The computed constant value 381 may then be provided to the dependent instruction 316 (i.e., the next deterministic instruction 316) via the constant cache 132, as indicated by arrow 389.

In FIG. 3H, the instruction processing circuit 300 again detects the deterministic instruction 316, and locates the entry 302(2), as indicated by arrow 390. The instruction processing circuit 300 in FIG. 3H may locate the entry 302(2) by determining that the attribute 368 of the deterministic instruction 316 matches the entry 302(2), and by further determining that the inputs 364 and 366 of the deterministic instruction 316 correspond to the operands 372 and 374 in the entry 302(2). Accordingly, the instruction processing circuit 300 again updates the entry 337(0) in the constant cache 132 with the computed constant value 382 provided by the entry 302(2), as indicated by arrow 391. The dependent instruction 318 may then be provided with the computed constant value 382 via the constant cache 132, as indicated by arrow 392.

FIG. 3I is provided to illustrate communications flows that may result if an instruction that was previously encountered in the instruction stream 310 with one set of inputs is later encountered with a different set of inputs. In this example, assume that a branch instruction (not shown) immediately following instruction 318 has returned the program flow to the deterministic instruction 314, and the instruction processing circuit 300 again detects the deterministic instruction 314 having the attribute 350 comprising the address B. When the deterministic instruction 314 was previously encountered, the input 352 corresponded to the entry 302(0) of the computed constants table 304, because the instruction 312 had been the last instruction to write to the register R0. In this instance, however, the register R0 was last written by the instruction 316, and therefore the input 352 corresponds to the entry 302(2) of the computed constants table 304. This may be determined by, for example, consulting the register mapping table 308 in FIG. 3H, and determining that the entry 332(0) indicates that the register R0 is mapped to row 2 (i.e., entry 302(2)) of the computed constants table 304.

Accordingly, the instruction processing circuit 300 checks the computed constants table 304, and determines that while the attribute 350 matches the entry 302(1), the input 352 in this example does not match the operand field 324(0) of the entry 302(1). The instruction processing circuit 300 thus generates another entry 302(3) in the computed constants table 304, and stores the attribute 350 of the deterministic instruction 314 in the PC field 320, as indicated by arrow 393. Because the input 352 of the deterministic instruction 314 corresponds to the existing entry 302(2), the instruction processing circuit 300 stores an ID of two (2) (i.e., a reference to the entry 302(2) of the computed constants table 304) in the operand field 324(0) of the entry 302(3) as an operand 394.

The instruction processing circuit 300 then generates the entry 326(0) in the in-flight instruction queue 306, as shown by arrow 395. In the entry 326(0), the attribute 350 of the deterministic instruction 314 is stored in the ID field 328, while an ID of three (3) for the entry 302(3) of the computed constants table 304 is stored in the table ID field 330. The instruction processing circuit 300 further updates the table ID field 336 of the entry 332(0) in the register mapping table 308 with an ID of three (3) referencing the entry 302(3) of the computed constants table 304, as indicated by arrow 396. This may serve to indicate to the instruction processing circuit 300 that the entry 302(3) will contain the most recent computed constant value for the register R0 corresponding to the input 352. Conventional processing of the deterministic instruction 314 then continues. After the deterministic instruction 314 is executed, the entry 302(3) is updated with a computed constant value 397 (in this example, the value 83).

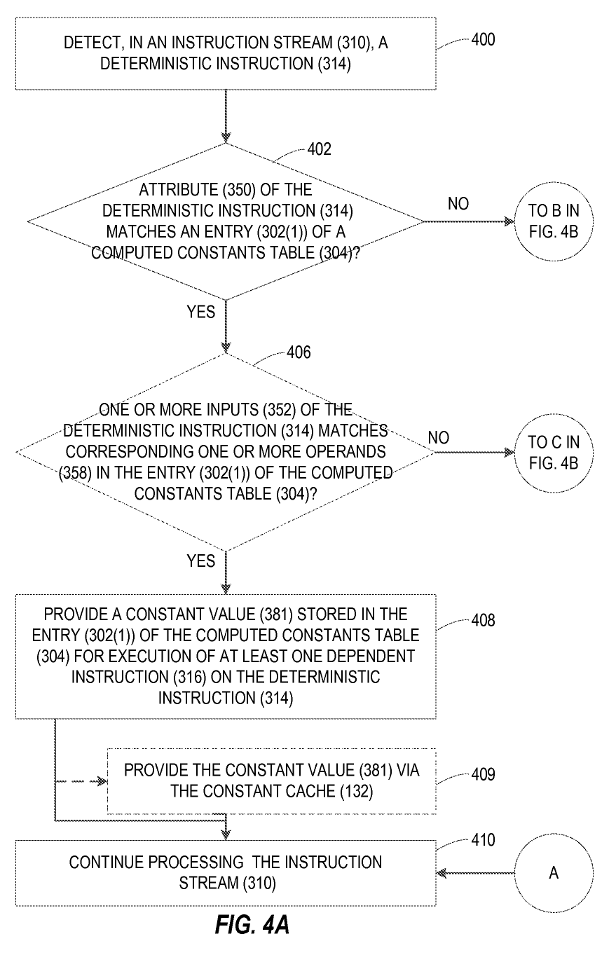

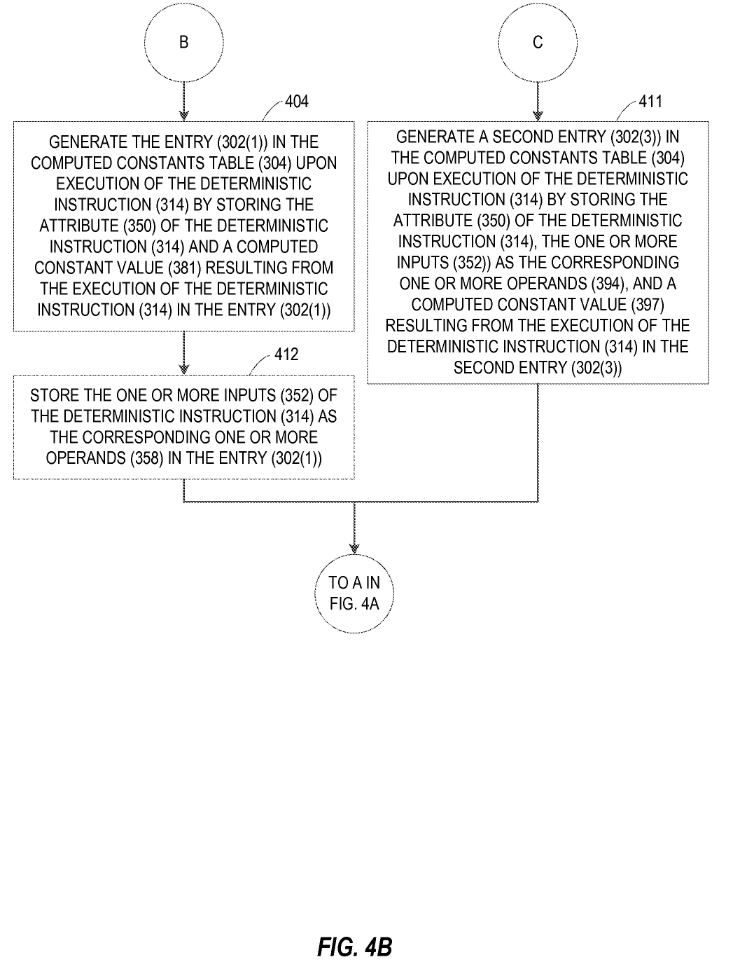

To illustrate exemplary operations for propagating constant values according to some aspects of the instruction processing circuit 102 and the computed constants table 104 of FIG. 1, FIGS. 4A and 4B are provided. In particular, FIG. 4A is a flowchart illustrating exemplary operations for providing a previously computed constant value from an entry in the computed constants table 104, while FIG. 4B is a flowchart illustrating exemplary operations for generating a new entry in the computed constants table 104. For the sake of clarity, elements of FIGS. 1 and 3A-3I are referenced in describing FIGS. 4A and 4B.

In FIG. 4A, operations begin with the instruction processing circuit 300, (which corresponds to the instruction processing circuit 102 of FIG. 1, in some aspects) detecting, in an instruction stream 310, a deterministic instruction 314 (block 400). Some aspects may provide that the deterministic instruction 314 is detected by determining that the deterministic instruction 314 operates on an immediate constant value, or takes as input only a constant value or a previously computed constant value in the computed constants table 304.

The instruction processing circuit 300 next determines whether an attribute 350 of the deterministic instruction 314 matches an entry 302(1) of the computed constants table 304 (block 402). If the attribute 350 of the deterministic instruction 314 does not match the entry 302(1), processing resumes at block 404 of FIG. 4B. Otherwise, the instruction processing circuit 300 in some aspects may further determine whether one or more inputs 352 of the deterministic instruction 314 matches a corresponding one or more operands 358 in the entry 302(1) of the computed constants table 304 (block 406). If so, the instruction processing circuit 300 provides a constant value 381 stored in the entry 302(1) of the computed constants table 304 for execution of at least one dependent instruction 316 on the deterministic instruction 314 (block 408). The instruction processing circuit 300 then continues processing the instruction stream 310 (block 410). However, if the instruction processing circuit 300 determines at decision block 406 that the one or more inputs 352 of the deterministic instruction 314 does not match the corresponding one or more operands 358 in the entry 302(1), processing resumes at block 411 of FIG. 4B.

Referring now to FIG. 4B, if the instruction processing circuit 300 determines at decision block 402 of FIG. 4A that the attribute 350 of the deterministic instruction 314 does not match the entry 302(1), the instruction processing circuit 300 generates the entry 302(1) in the computed constants table 304 upon execution of the deterministic instruction 314 (block 404). Generating the entry 302(1) may include storing the attribute 350 of the deterministic instruction 314 and a computed constant value 381 resulting from the execution of the deterministic instruction 314 in the entry 302(1). It is to be understood that the entry 302(1) may be generated prior to the deterministic instruction 314 being executed, and may be updated with the computed constant value 381 after the deterministic instruction 314 is executed. In some aspects, the instruction processing circuit 300 may also store the one or more inputs 352 of the deterministic instruction 314 as a corresponding one or more operands 358 in the entry 302(1) (block 412). Processing then resumes at block 410 of FIG. 4A.

With continuing reference to FIG. 4B, if the instruction processing circuit 300 determines at decision block 406 of FIG. 4A that the one or more inputs 352 of the deterministic instruction 314 does not match the corresponding one or more operands 358 in the entry 302(1), the instruction processing circuit 300 generates the second entry 302(3) in the computed constants table 304 upon execution of the deterministic instruction 314 (block 411). Generating the entry 302(3) may include storing the attribute 350 of the deterministic instruction 314, the one or more inputs 352 as the corresponding one or more operands 394, and a computed constant value 397 resulting from the execution of the deterministic instruction 314 in the second entry 302(3). The entry 302(3) may be generated prior to the deterministic instruction 314 being executed, and may be updated with the computed constant value 397 after the deterministic instruction 314 is executed. Processing then resumes at block 410 of FIG. 4A.

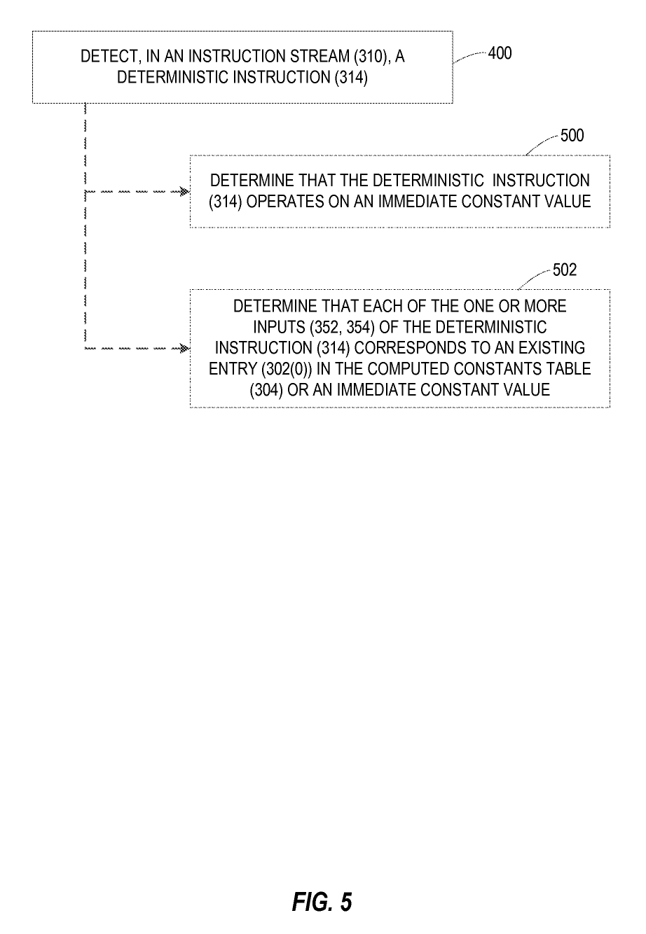

FIG. 5 illustrates exemplary operations of the instruction processing circuit 102 of FIG. 1 for detecting a deterministic instruction in some aspects. As seen in FIG. 5, these exemplary operations may correspond to the operations of block 400 in FIG. 4A. In some aspects, the instruction processing circuit 102 may detect the deterministic instruction 314 by determining that the deterministic instruction 314 operates on an immediate constant value (block 500). Some aspects may provide that the instruction processing circuit 102 may detect the deterministic instruction 314 by determining that each of the one or more inputs 352, 354 of the deterministic instruction 314 correspond to an existing entry 302(0) in the computed constants table 304 or an immediate constant value (block 502). It is to be understood that the instruction processing circuit 102 according to aspects described herein may employ other and/or additional operations for detecting a deterministic instruction.

Propagating constant values using a computed constants table according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

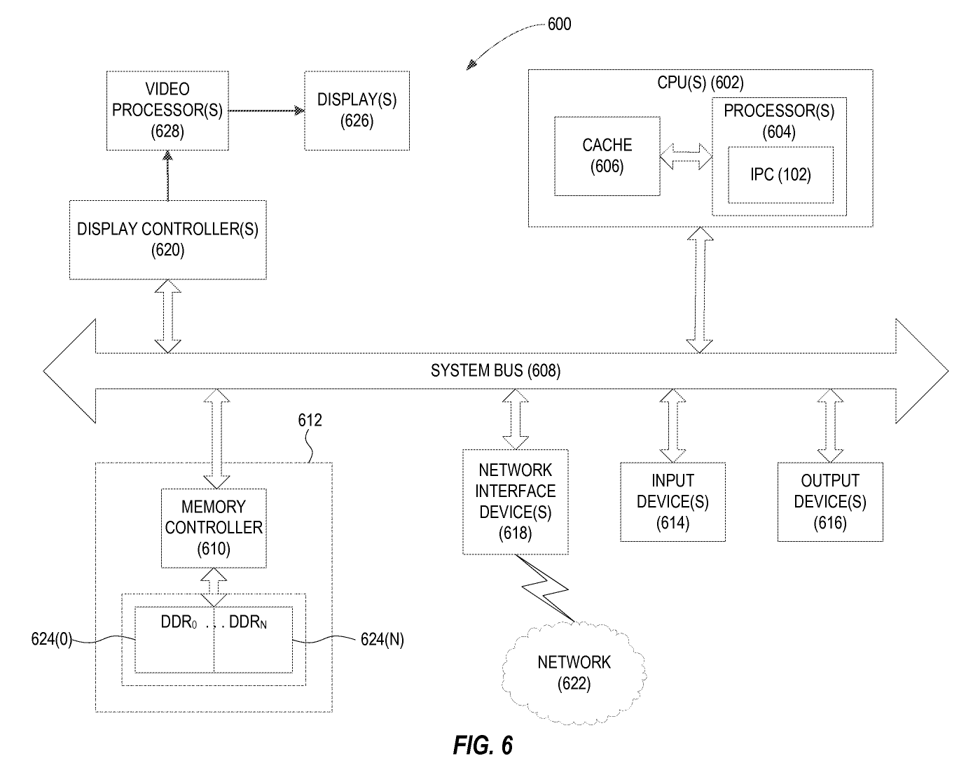

In this regard, FIG. 6 illustrates an example of a processor-based system 600 that can employ the instruction processing circuit 102 of FIG. 1. In this example, the processor-based system 600 includes one or more central processing units (CPUs) 602, each including one or more processors 604. The one or more processors 604 may include the instruction processing circuit (IPC) 102 of FIGS. 1 and 3A-3I. The CPU(s) 602 may be a master device. The CPU(s) 602 may have cache memory 606 coupled to the processor(s) 604 for rapid access to temporarily stored data. The CPU(s) 602 is coupled to a system bus 608 and can intercouple master and slave devices included in the processor-based system 600. As is well known, the CPU(s) 602 communicates with these other devices by exchanging address, control, and data information over the system bus 608. For example, the CPU(s) 602 can communicate bus transaction requests to a memory controller 610 as an example of a slave device.

Other master and slave devices can be connected to the system bus 608. As illustrated in FIG. 6, these devices can include a memory system 612, one or more input devices 614, one or more output devices 616, one or more network interface devices 618, and one or more display controllers 620, as examples. The input device(s) 614 can include any type of input device, including but not limited to input keys, switches, voice processors, etc. The output device(s) 616 can include any type of output device, including but not limited to audio, video, other visual indicators, etc. The network interface device(s) 618 can be any devices configured to allow exchange of data to and from a network 622. The network 622 can be any type of network, including but not limited to a wired or wireless network, a private or public network, a local area network (LAN), a wide local area network (WLAN), and the Internet. The network interface device(s) 618 can be configured to support any type of communications protocol desired. The memory system 612 can include the memory controller 610 and one or more memory units 624(0-N).

The CPU(s) 602 may also be configured to access the display controller(s) 620 over the system bus 608 to control information sent to one or more displays 626. The display controller(s) 620 sends information to the display(s) 626 to be displayed via one or more video processors 628, which process the information to be displayed into a format suitable for the display(s) 626. The display(s) 626 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. An apparatus comprising an instruction processing circuit, the instruction processing circuit configured to:
detect, in an instruction stream, a deterministic instruction;
determine whether an attribute of the deterministic instruction matches an entry of a computed constants table; and
responsive to determining that the attribute of the deterministic instruction matches the entry of the computed constants table, provide a constant value stored in the entry of the computed constants table for execution of at least one dependent instruction on the deterministic instruction.

2. The apparatus of claim 1, wherein the instruction processing circuit is further configured to:
communicatively couple the instruction processing circuit to a constant cache; and
provide the constant value stored in the entry of the computed constants table via the constant cache.

3. The apparatus of claim 1, wherein the instruction processing circuit is further configured to, responsive to determining that the attribute of the deterministic instruction does not match the entry of the computed constants table, generate the entry in the computed constants table upon execution of the deterministic instruction by storing the attribute of the deterministic instruction and a computed constant value resulting from the execution of the deterministic instruction in the entry.

4. The apparatus of claim 3, wherein the instruction processing circuit is further configured to generate the entry in the computed constants table by storing one or more inputs of the deterministic instruction as a corresponding one or more operands in the entry.

5. The apparatus of claim 4, wherein each of the one or more inputs of the deterministic instruction stored in the entry as an operand is selected from the group consisting of: a constant value and a reference to an existing entry in the computed constants table.

6. The apparatus of claim 1, wherein the instruction processing circuit is further configured to, responsive to determining that the attribute of the deterministic instruction matches the entry of the computed constants table, determine whether each of one or more inputs of the deterministic instruction matches a corresponding one or more operands in the entry of the computed constants table;
the instruction processing circuit configured to provide the constant value stored in the entry of the computed constants table responsive to determining that each of the one or more inputs of the deterministic instruction matches the corresponding one or more operands in the entry of the computed constants table.

7. The apparatus of claim 6, wherein the instruction processing circuit is further configured to, responsive to determining that at least one of the one or more inputs of the deterministic instruction does not match the corresponding one or more operands in the entry of the computed constants table, generate a second entry in the computed constants table upon execution of the deterministic instruction by storing the attribute of the deterministic instruction, the one or more inputs as the corresponding one or more operands, and a computed constant value resulting from the execution of the deterministic instruction in the second entry.

8. The apparatus of claim 1 integrated into an integrated circuit (IC).

9. The apparatus of claim 1 integrated into a device selected from the group consisting of: a set top box; an entertainment unit; a navigation device; a communications device; a fixed location data unit; a mobile location data unit; a mobile phone; a cellular phone; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; and a portable digital video player.

10. A method for providing constant propagation, comprising:
detecting, in an instruction stream, a deterministic instruction;
determining whether an attribute of the deterministic instruction matches an entry of a computed constants table; and
responsive to determining that the attribute of the deterministic instruction matches the entry of the computed constants table, providing a constant value stored in the entry of the computed constants table for execution of at least one dependent instruction on the deterministic instruction.

11. The method of claim 10, wherein providing the constant value stored in the entry of the computed constants table comprises providing the constant value via a constant cache.

12. The method of claim 10, further comprising, responsive to determining that the attribute of the deterministic instruction does not match the entry of the computed constants table, generating the entry in the computed constants table upon execution of the deterministic instruction by storing the attribute of the deterministic instruction and a computed constant value resulting from the execution of the deterministic instruction in the entry.

13. The method of claim 12, wherein generating the entry in the computed constants table further comprises storing one or more inputs of the deterministic instruction as a corresponding one or more operands in the entry.

14. The method of claim 13, wherein storing the one or more inputs of the deterministic instruction as the corresponding one or more operands in the entry comprises storing each of the one or more inputs of the deterministic instruction in the entry as an operand selected from the group consisting of: a constant value and a reference to an existing entry in the computed constants table.

15. The method of claim 10, further comprising, responsive to determining that the attribute of the deterministic instruction matches the entry of the computed constants table, determining whether each of one or more inputs of the deterministic instruction matches a corresponding one or more operands in the entry of the computed constants table;
wherein providing the constant value stored in the entry of the computed constants table comprises providing the constant value responsive to determining that each of the one or more inputs of the deterministic instruction matches the corresponding one or more operands in the entry of the computed constants table.

16. The method of claim 15, further comprising, responsive to determining that at least one of the one or more inputs of the deterministic instruction does not match the corresponding one or more operands in the entry of the computed constants table, generating a second entry in the computed constants table upon execution of the deterministic instruction by storing the attribute of the deterministic instruction, the one or more inputs as the corresponding one or more operands, and a computed constant value resulting from the execution of the deterministic instruction in the second entry.

17. An apparatus comprising an instruction processing circuit, the instruction processing circuit comprising:
a means for detecting, in an instruction stream, a deterministic instruction;
a means for determining whether an attribute of the deterministic instruction matches an entry of a computed constants table; and
a means for providing a constant value stored in the entry of the computed constants table for execution of at least one dependent instruction on the deterministic instruction responsive to determining that the attribute of the deterministic instruction matches the entry of the computed constants table.

18. The apparatus of claim 17, wherein the means for providing the constant value stored in the entry of the computed constants table comprises a constant cache.

19. The apparatus of claim 17 further comprising a means for generating the entry in the computed constants table upon execution of the deterministic instruction by storing the attribute of the deterministic instruction and a computed constant value resulting from the execution of the deterministic instruction in the entry, responsive to determining that the attribute of the deterministic instruction does not match the entry of the computed constants table.

20. The apparatus of claim 17 further comprising:
a means for determining whether one or more inputs of the deterministic instruction matches a corresponding one or more operands in the entry of the computed constants table, responsive to determining that the attribute of the deterministic instruction matches the entry of the computed constants table; and
a means for providing the constant value stored in the entry of the computed constants table responsive to determining that the one or more inputs of the deterministic instruction matches the corresponding one or more operands in the entry of the computed constants table.
